(19) United States
(12) Patent Application Publication
(10) Pub. No.: US 2010/0313409 A1
(43) Pub. Date: Dec. 16, 2010

(54) HYBRID BUTTON

(75) Inventors: Douglas J. Weber, Arcadia, CA (US); Pinida Jan Moolsintong, San Francisco, CA (US); Stephen P. Zadesky, Portola Valley, CA (US)

Correspondence Address: APPLE c/o MOFO LA, 555 WEST FIFTH STREET SUITE 3500, SUITE 200, LOS ANGELES, CA, 90013-1024, US

(73) Assignee: Apple Inc., Cupertino, CA (US)

(21) Appl. No.: 12/844,502

(22) Filed: Jul. 27, 2010

Related U.S. Application Data
(62) Division of application No. 11/519,259, filed on Sep. 11, 2006, now Pat. No. 7,795,553.

(51) Int. Cl. H01H 11/00

(52) U.S. Cl. 29/622

(57) ABSTRACT

A hybrid button according to the invention is provided. In one embodiment, the button can be implemented in an electronic device such as a media player. The button can include a metal or other non-plastic portion having a reverse flange and a plastic portion including anti-rotation legs. The legs can prevent rotation at least in part because they are retained by another structure. The plastic portion can be injection-molded onto the reverse flange of the metal or non-plastic portion. As such, the reverse flange fixes the position of the plastic portion with respect to the metal portion. Finally, the metal portion can include an actuator nub that actuates a switch when the button is depressed.

### REFERENCE TO RELATED APPLICATIONS

This application is a divisional of U.S. patent application Ser. No. 11/519,259 filed on Sep. 11, 2006, now allowed.

### BACKGROUND OF THE INVENTION

This invention can relate to buttons with improved strength and durability. More particularly, this invention can relate to hybrid buttons formed from plastic and at least one additional material.

For example, conventional center-mounted buttons on selected models of the iPod™ media player made by Apple Computer, Inc., of Cupertino, Calif. are formed from plastic and incorporate certain design functionality. These buttons include distinct mechanical anti-rotation features that are formed using conventional manufacturing techniques.

Although media players such as these work well, it can be desirable to retain design functionality of the center-mounted button on an iPod™, or other similar media player, while providing the center-mounted button a metallic or other non-plastic cosmetic finish and to provide an improved surface for engaging the button.

### SUMMARY OF THE INVENTION

The invention can relate to retaining certain design functionality, such as anti-rotation, of a center-mounted button on an iPod™, or other similar media player, and providing additional functionality, such as forming the center-mounted button in non-planar (e.g., concave) that was previously difficult to manufacture within the design specifications of the button when it was formed wholly in plastic.

In one embodiment, this invention can relate to a portable media player. The portable media player can include a housing, which can include an Input/Output (I/O) platform. The I/O platform can be in the form of one or more buttons.

This invention can also relate to buttons for use in cellular phones, personal digital assistants (PDAs), video games, radios, MP3 players, CD players, DVD players, televisions, game players, cameras, etc.

In one embodiment, a button according to the invention can retain design functionality of the center-mounted button, while providing the center-mounted button a metal or other non-plastic cosmetic finish.

A button according to one embodiment of the invention can also retain various mechanical functions, such as anti-rotation, easily implemented in plastic buttons. A button according to the invention can also provide additional functionality such as providing an upper face formed in a concave shape, such shape that was previously substantially unobtainable within the design specifications of the button when it was formed wholly in a cosmetically-desirable plastic.

A method of manufacturing a button according to one embodiment of the invention can include lathing a non-plastic upper portion of the button whereby the lathing includes forming a reverse flange in the upper non-plastic portion of the button, anodizing the non-plastic upper portion following the forming of the non-plastic upper portion, and injection-molding a plastic lower portion of the button onto the non-plastic upper portion of the button. The injection-molding can include fixing the position of the plastic lower portion with respect to the non-plastic upper portion by injection-molding at least a portion of the lower portion into the reverse flange.

It should be noted that a button according to the invention formed from at least partially from a metallic material may exhibit greater reliability, strength, dependability and electrical properties such as conductivity. Such properties can substantially improve the functionality of the button. Furthermore, a metallic or other non-plastic button may exhibit improved cosmetic properties because the material of the button can be matched to the material of the housing, thereby improving the look and feel of the button and harmonizing the look and feel of the electronic device.

### BRIEF DESCRIPTION OF THE DRAWINGS

The following detailed description of the embodiment of the present disclosure can best be understood when read in conjunction with the following drawings in which features are not necessarily drawn to scale but rather are drawn as to best illustrate the pertinent features.

FIG. 1 is a perspective view of a media player according to the invention.

FIG. 2 is an enlarged cross-sectional of a button and scroll wheel according to the invention taken from line A-A of FIG. 1.

FIG. 3 is an enlarged view of a cut-out portion taken from line B of FIG. 2.

FIG. 4 is an exploded perspective view of the components of a button according to the invention.

FIG. 5 is a perspective view shown from above of the button according to the invention.

FIG. 6 is a perspective view shown from below of a button according to the invention.

FIG. 7 is an exploded perspective view of the center molded button and flexible printed circuit according to the invention.

FIG. 8 is a perspective view shown from below of another embodiment of a button according to the invention.

FIG. 9 is a flowchart of possible embodiments of methods according to the invention.

### DETAILED DESCRIPTION OF THE INVENTION

A button according to the invention can include a non-plastic portion formed with a computer-numerically controlled (CNC) lathe and a plastic injection-molded portion that can be injection-molded directly onto the non-plastic portion.

One purpose of the injection-molded center button according to the invention can be to retain all-plastic button design functionality.

In one embodiment, the button can present an anodized aluminum surface or other metallic surface to a user when the non-plastic portion is formed from a metal. The button can also present a rotationally symmetric (e.g., concave) surface to the user while achieving, or even exceeding, the design specifications of the all-plastic button. Additionally, the injection-molded button according to the invention may be produced in relatively high volumes at a relatively low cost to meet high production requirements.

As mentioned above, one method of forming a button is to make a metal portion of the button using a CNC-lathe, which can be used to obtain a button surface shape of a predetermined finish, (e.g., a textured face, a concave face, etc.).

Nevertheless, certain functions (e.g., rotation prevention, adaptability to couple to a specific flexible printed circuit (FPC) relief, such as the ability to provide a space for a portion of the FPC to pass therethrough, retention flange and/or other features) cannot easily be obtained in a part that was completely formed with a CNC-lathe because conventional lathing can only shape the metal portion of the button around a rotational axis. Although features may be added to metal portions through additional processing (e.g., milling), such an addition could be both time consuming and costly.

In one embodiment of the invention, the button can be manufactured as follows: An upper non-plastic portion of the button is formed using a CNC-lathe. The non-plastic portion can be formed to include a machined-concave face. The non-plastic portion can also be further formed to include an undercut retention feature suitable for accepting a plastic ledge. The non-plastic portion can be further formed to incorporate a center button actuator nub on the underside—i.e., the side that faces away from a user—of the button. This non-plastic portion of the button can be finished on the lathe to a very fine finish, and then anodized according to any known anodization processes.

The finished anodized part can then be placed in an injection-molding cavity of an injection-molding machine. An additional plastic element (or elements) can then be injection-molded onto the underside of the non-plastic portion of the button (or, in alternative embodiments, on any suitable location on the button).

Alternatively, other embodiments of the invention can include an all-metal button that does not include an anti-rotation feature but does include FPC relief, which was machined or coined into the retainer plate on the underside of the button.

Yet another aspect of the invention relates to the additional advantages obtained by forming at least a portion of the button from a material other than plastic. For example, plastic iPod™ buttons formed from commercially-available resins such as ABS, PC, AND ABS-PC, are normally only formed at thicknesses of greater than 0.5 millimeters. When the plastic button is formed thinner than 0.5 millimeters, surface quality can degrade at least because the actuator nub, which is typically formed on the underside of the button, can show through to the concave face of the button because of limitations in the flow of the plastic. A button formed according to the invention, however, can be formed at thicknesses of about 0.5 millimeters, about 0.3 millimeters, or even less, because of superior metallic and/or other non-plastic properties and processing.

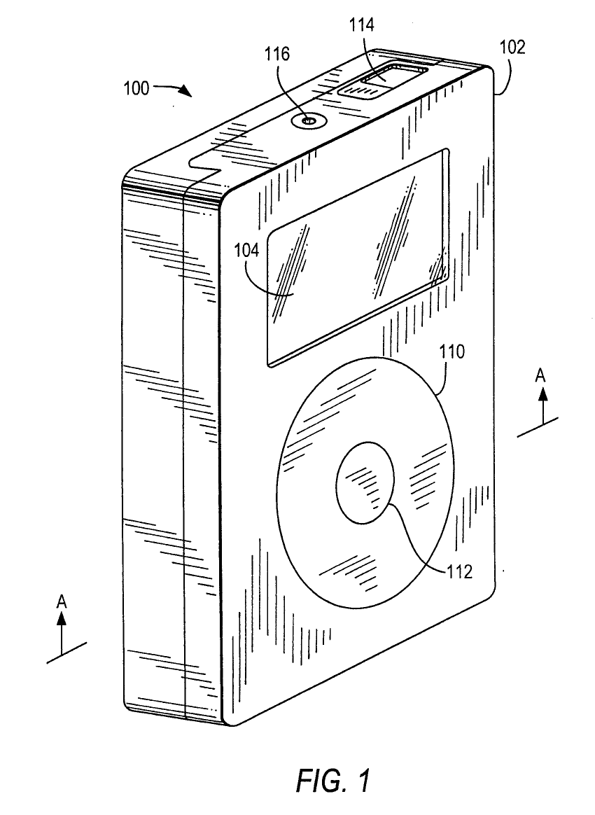

A number of embodiments of this invention are described below with reference to FIGS. 1-9. However, those skilled in the art will readily appreciate that the detailed description given herein with respect to these figures is for explanatory purposes as the invention extends beyond these limited embodiments.

FIG. 1 is a top plan view of a center button housed in a media player 100 according to one embodiment of the invention. The term “media player” generally refers to computing devices that are dedicated to processing media such as audio, video or other images, as for example, music players, game players, video players, video recorders, cameras, and the like. In some cases, the media players may perform a single functional (e.g., a media player dedicated to playing music) and in other cases perform multiple functions (e.g., a media player that plays music, displays video, stores pictures, and the like). In either case, these devices are generally portable so as to allow a user to listen to music, play games or video, record video or take pictures wherever the user travels. Alternatively, the devices that incorporate a button according to this invention may not be portable at all.

Electronic device 10 can also be any handheld, or miniature consumer electronic device. Miniature electronic devices may have a form factor that is smaller than that of hand-held devices. Illustrative miniature electronic devices can include, but are not limited to, watches, rings, necklaces, belts, accessories for belts, headsets, accessories for shoes, virtual reality devices, other wearable electronics, accessories for sporting equipment, accessories for fitness equipment, or combinations thereof.

In the illustrated embodiment in FIG. 1, media player 100 can be a pocket-sized hand-held MP3 music player that allows a user to store a collection of music (e.g., in some cases up to 4,000 CD-quality songs). Although used primarily for storing and playing music, the MP3 music player shown herein can also include additional functionality, such as storing a calendar and phone lists, storing and playing games, storing photos, and the like.

FIG. 1 also shows housing 102, display screen 104, scroll wheel 110, concave-faced upper non-plastic portion of center button 112, that can be used for user navigation through a user interface, holdswitch 114, and earphone jack 116 of media player. Housing 102 can host center button 112, and can in fact be configured to retain scroll wheel 110 in its position in the media player. The navigation can be implemented in the form of transmission of user instructions in response to user stimulus on scroll wheel 110.

Scroll wheel 110, which can alternatively be referred to herein as a touchpad, is an intuitive interface that can provide easy one-handed operation i.e., it lets a user interact with the media player with one or more fingers. Scroll wheel 110 can be configured to provide one or more control functions associated with the media player.

In one embodiment of the invention, button 112 can be implemented without scroll wheel 110. Alternatively, the position of button 112 can be widely varied relative to scroll wheel 110 and housing 102. For example, they can be adjacent one another or spaced apart. In the illustrated embodiment, button 112 is configured to be surrounded by scroll wheel 110. In this manner, button 112 can provide a tangible surface that defines the inner boundary of scroll wheel 110. Alternatively, a single device may have multiple buttons (not shown). By way of example, a plurality of buttons can include a menu button, a play/stop button, a forward seek button and a reverse seek button, and the like. Additionally, button 112 can be placed at any external surface (e.g., top, side, front, or back) of housing 102 that is accessible to a user during manipulation of the media player. Furthermore, button 112 can be integrated with scroll wheel 110, as shown in FIG. 1, or with some other user interface feature on the media player, such as switches, keys, dials, trackballs, joysticks, touch pads, touch screens, displays, microphones, speakers, cameras and the like. Each of these individual interfaces may include buttons either incorporate therein such as a button on a joystick, or forming an integral part thereof such as a switch with button located thereon or a touch screen or touch pad with a button located therewithin which may not operate similar to the touch pad—i.e., in a touch-sensitive fashion but can operate in response to a mechanical force.

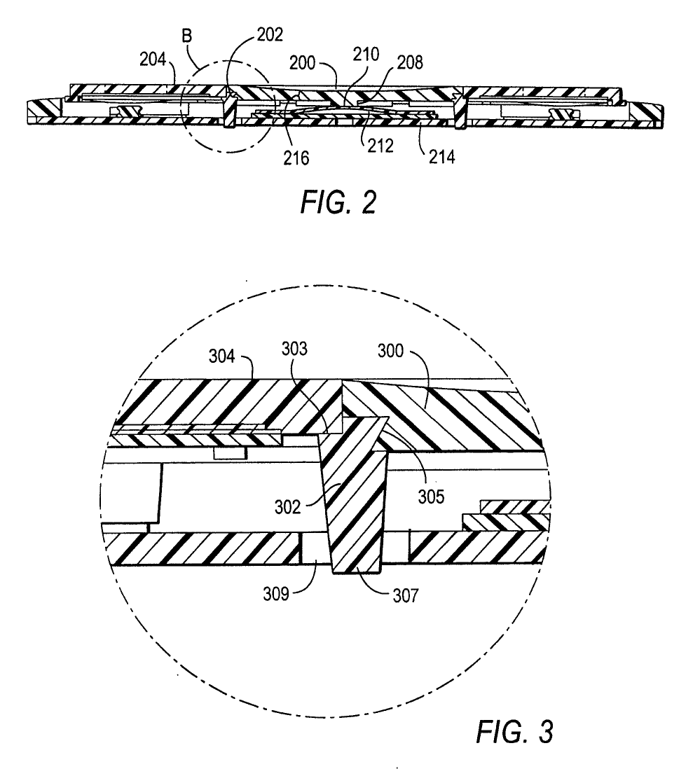

Further, button 112 can be configured to provide one or more dedicated control functions for making selections or issuing commands associated with operating the media player. By way of example, in the case of an MP3 music player, the button functions can be associated with opening a menu, playing a song, fast forwarding a song, seeking through a menu and the like. In most cases, the button functions are implemented via a mechanical clicking action. For example, dome switch 210 in FIG. 2 can be configured to produce a mechanical and/or audible clicking action upon actuation.

Housing 102 can include integrated circuit chips and other circuitry. Such circuitry can include a microprocessor (e.g., CPU), memory (e.g., ROM, RAM), a power supply (e.g., battery), a circuit board, a hard drive, other memory (e.g., flash) and/or various I/O support circuitry. The electrical components can also include components for inputting or outputting music or sound such as a microphone, amplifier and a digital signal processor (DSP). The electrical components can also include components for capturing images such as image sensors (e.g., charge coupled device (CCD) or include complimentary oxide semiconductor (CMOS)) or optics (e.g., lenses, splitters, filters etc.). The electrical components can also include components for sending and receiving media (e.g., antenna, receiver, transmitter, transceiver, etc.).

A user interface for the media player can be formed from button 112 and scroll wheel 110, among other things, such as a speaker for audible feedback or a vibratory mechanism for providing tactile feedback. While the user interface can be widely varied, this invention can relate to the implementation of buttons on a number of user interface variations. Such variations, which are described in greater detail above, can include buttons implemented on switches, keys, dials, trackballs, joysticks, touch pads, touch screens, displays, microphones, speakers, cameras and the like.

FIG. 2 is an enlarged cross-sectional view of a center button and scroll wheel according to the specific embodiment of the invention taken from line AA of FIG. 1. The button shown in FIG. 2 can include non-plastic portion 200, which can itself have a concave surface actuator nub 208 on the underside of non-plastic portion 200.

FIG. 2 also shows plastic portion 202 of the center button. Plastic portion 202 can be injection-molded onto non-plastic portion 200 after non-plastic portion 200 is made. The interconnection between non-plastic portion 200 and plastic portion 202 is enlarged in FIG. 3 and described in greater detail below.

FIG. 2 also shows scroll wheel 204 and center dome switch 210, which can be located on FPC 212, which, in turn, can be located on back plate 214. Actuator nub 208 can be actuated to activate dome switch 210. FIG. 2 also shows the thickness of annulus 216, which can be lathed to a thickness of less than 0.5 millimeters and, in some embodiments, between about 0.3 millimeters and about 0.5 millimeters while still providing the desired functionality typically associated with an all-plastic button.

FIG. 3 is an enlarged view of a cut-out portion of FIG. 2 taken from line B. FIG. 3 shows non-plastic portion 300 of center button 112, plastic portion 302 of center button 112, and flange 303 formed in plastic portion 302 that abuts against the underside of scroll wheel 304. Flange 303 can allow scroll wheel 304 to maintain center button 112 in a stationary position in the plane of the button.

FIG. 3 also shows reverse flange 305 in non-plastic portion 300 that creates a mechanical undercut so that plastic portion 302 does not separate from non-plastic portion 300 after molding. Plastic portion 302 also can include one or more anti-rotation legs 307 that can extend downward into the device. Legs 307 can limit or prevent rotation of the button with respect to the device. This concern is especially significant when the button is centered in a scroll wheel because 10 the rotation of a user's finger around a scroll wheel can provide rotational forces to the button.

FIG. 3 also shows apertures 309 located in the back plate for anti-rotation legs to pass through and to be constrained therein from rotating along a rotational axis about a longitudinal axis (see rotational axis 613 shown in FIG. 6).

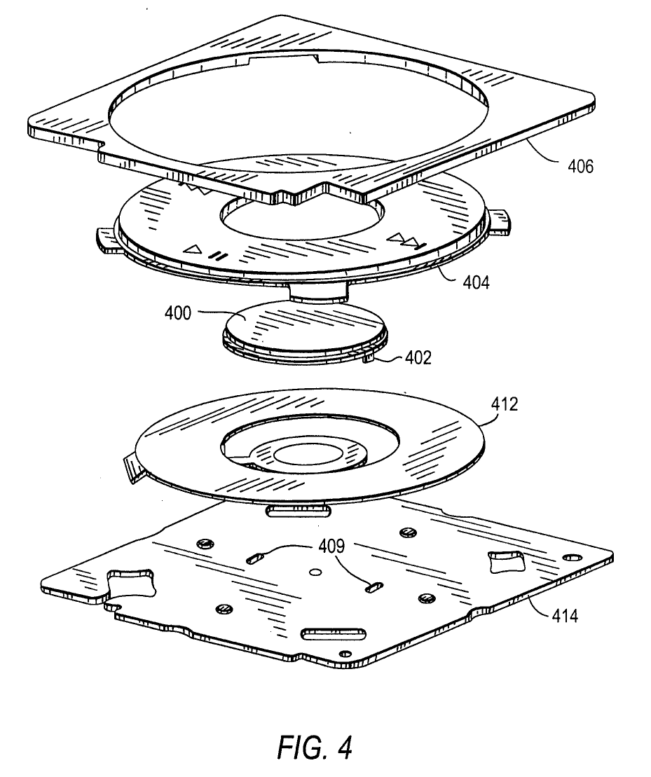

FIG. 4 is an exploded perspective view of the components of a center-mounted button according to one embodiment of the invention. FIG. 4 illustrates center button 402 according to the invention, scroll wheel 404, scroll wheel retainer 406, anti-rotation apertures 409, FPC 412 including dome switches, and retainer plate 414.

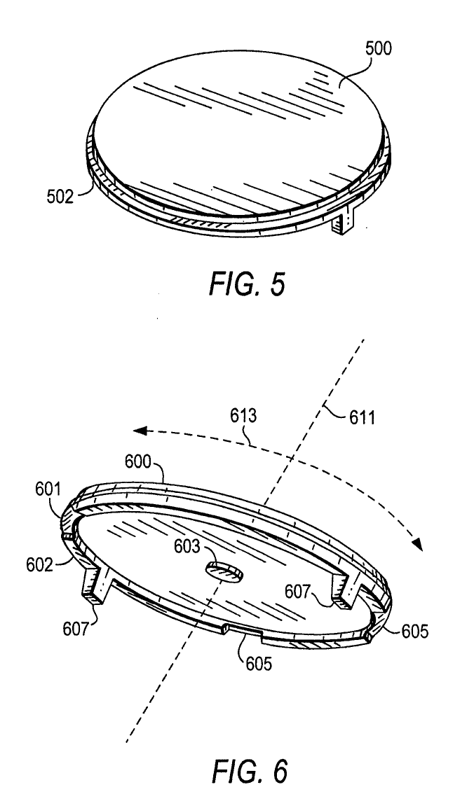

FIG. 5 is a perspective view of the button according to one embodiment of the invention shown from above. FIG. 5 shows non-plastic portion of button 500, and plastic portion of button 502.

FIG. 6 is a perspective view of the button according to one embodiment of the invention shown from below. FIG. 6 shows non-plastic portion 600 of the button according to the invention, plastic portion 602, FPC tail relief 601, center button dome switch actuator nub 603 formed on the underside of non-plastic portion 600, gating spots 605 for additional circuitry and anti-rotation legs 607. FIG. 6 also shows longitudinal axis 611 of the button as well. Furthermore, FIG. 6 shows rotational axis 613 of the button. While the button according to the invention may not rotate about rotational axis 613, nevertheless rotational axis 613 has been shown to illustrate the direction of the forces that anti-rotation legs 607 counteract. Rotational axis 613 has also been shown to illustrate the axis in which designs can be implemented using a CNC-lathe, as described in more detail above. It can be seen from this perspective that lower plastic portion 602 has been injection-molded into the reverse flange of upper non-plastic portion 600. Once molded, the reverse flange can substantially trap lower plastic portion 602 from moving with respect to upper non-plastic portion 600. Furthermore, the reverse flange can make it difficult to remove lower plastic portion 602, or to replace lower plastic portion 602 once removed.

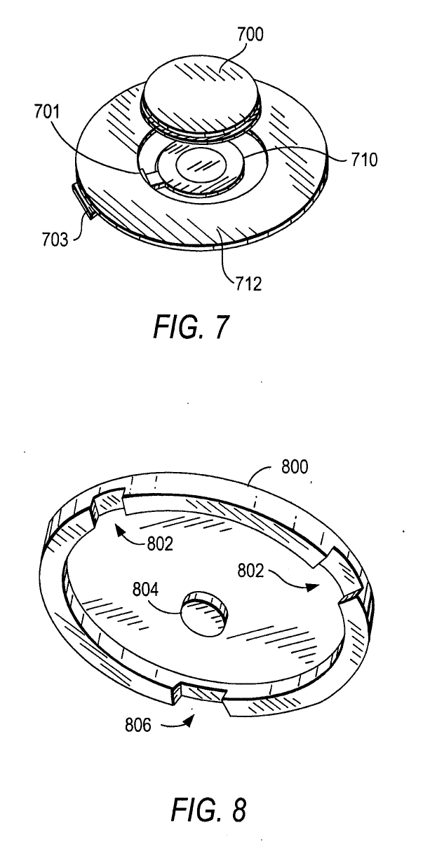

FIG. 7 is an exploded perspective view of the center molded button and flexible printed circuit according to the invention. FIG. 7 shows button's non-plastic portion 700, tail 701 from the center dome switch 710 that runs through FPC tail relief 601 (shown in FIG. 6 and also in FIG. 8 as FPC tail relief 806), tail 703 that can transmit signals to the main logic board (not shown) and FPC 712 that can include the dome switches.

In other embodiments of the invention, a media player can include an all-metal button that does not include an anti-rotation feature but does include FPC relief which was machined or coined into the retainer plate on the underside of the button.

FIG. 8 shows an exemplary illustration of an all-metal button 800 according to the aforementioned embodiments. While button 800 does not include the anti-rotation legs shown in other embodiments above, button 800 does incorporate gating spots at 802, dome switch actuator nub 804 and FPC tail relief 806. In a method according to the embodiment, FPC relief 806 can be coined or machined into the surface of button 800 before, after, or, in some embodiments during certain aspects of the lathing process.

While this invention has been described in terms of several preferred embodiments, there are alterations, permutations, and equivalents, which fall within the scope of this invention. For example, although the invention has been largely described in terms of a music player, it should be appreciated that the invention can also be applied to other types of devices.

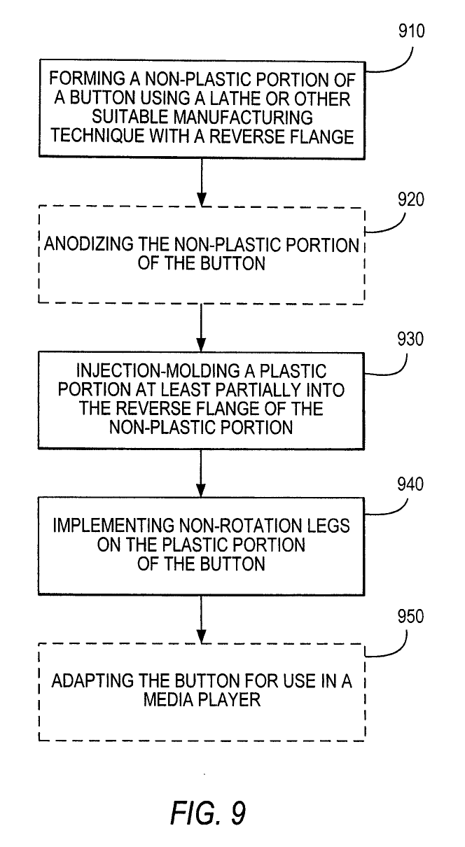

FIG. 9 shows various embodiments of a method according to the invention. Step 910 shows forming a non-plastic portion of a button using a lathe or other suitable manufacturing technique with a reverse flange. Step 920, which is shown to be an optional step by the dotted lines, shows anodizing the non-plastic portion of the button. Anodizing may be implemented on a metallic surface. Step 930 shows injection-molding a plastic portion at least partially into the reverse flange of the non-plastic portion. Step 940 shows implementing non-rotation legs on the plastic portion of the button. Step 950 shows the optional step of adapting the button for use in a media player. Such adapting may take the form of configuring the plastic portion of the button with certain gating spots or FPC relief in order to make the button usable with certain circuitry or adjusting the button in some other suitable fashion.

The method according to the invention can preferably implemented by a combination of hardware and software, but can also be implemented in hardware or software. The method can also be embodied as computer readable code on a computer readable medium. The computer readable medium is any data storage device that can store data which can thereafter be read by a computer system. Examples of the computer readable medium include read-only memory, random-access memory, hard drive, flash memory, CD-ROMs, DVDs, magnetic tape, optical data storage devices, and carrier waves.

In yet another alternative embodiment of the invention, the plastic portion of the button may be implemented using rubber or other material that is more flexible than some types of injection-molded plastic. In such an embodiment, the more flexible material would not have to be injected-molded onto the other portion (hereinbefore referred to as the “non-plastic” portion) of the button. Rather, the material could be stretched onto the reverse flange of the other portion of the button providing that the flexible portion retained sufficient grip on the reverse flange of the other portion of the button to remain stationary with respect to the other portion of the button for an extended time.

It is therefore intended that the following appended claims be interpreted as including all such alterations, permutations, and equivalents as fall within the true spirit and scope of the present invention. The embodiments described herein-above are further intended to explain the best modes known of practicing the invention and to enable others skilled in the art to utilize the invention in such, or other embodiments and with the various modifications required by the particular applications or uses of the invention.

Accordingly, the description is not intended to limit the invention to the form disclosed herein. Also, it is intended that the appended claims be construed to include alternative embodiments.

1-36. (canceled)

37. A method of manufacturing a button, the method comprising:
forming a metal portion of the button using a computer-numeric controlled lathe, the button comprising a reverse flange; and
injection-molding a plastic portion of the button onto the metal portion, the injection-molding comprising injection-molding the plastic portion into the reverse flange, the injection-molding comprising further comprising fixing the position of at least a portion of the plastic portion with respect to the metal portion.

38. The method of claim 37 further comprising anodizing the metal portion following the forming of the metal portion and prior to the injection-molding of the plastic portion.

39. The method of claim 37 further comprising lathing the metal portion of the button to a thickness of less than 0.4 millimeters.

40. The method of claim 37 further comprising forming a dome switch actuating nub on the underside of the metal portion of the button.

41. The method of claim 37, further comprising fixing the location of the plastic portion along a longitudinal axis of the button.

42. The method of claim 37, further comprising the fixing the location of the button along a rotational axis.

43. A method of manufacturing a button, the method comprising:
lathing a metal central portion of the button, the button comprising a reverse flange;
anodizing the metal central portion following the lathing of the metal portion; and
following the anodizing, injection-molding a plastic annular portion of the button onto the metal central portion of the lathe, the injection-molding comprising fixing the position of the plastic annular portion with respect to the metal central portion by injection-molding at least a portion of the annular portion into the reverse flange.

44. The method of claim 43 further comprising lathing the metal central portion of the button wherein the metal central portion comprises at least one annulus having a thickness of less than 0.4 millimeters.

45. The method of claim 43 further comprising forming a dome-switch actuator nub on the underside of the metal central portion of the button.

46. The method of claim 43 further comprising forming a flange in the plastic annular portion, said flange used for fixing the location of the plastic annular portion along a longitudinal axis of the button.

47. A method of manufacturing an electronic device comprising:
forming a base plate comprising a plurality of apertures;
forming a flexible printed circuit board that is adapted to receive user stimulus and transmit user commands to a microprocessor in response to the stimulus; and
forming a button comprising:
a metal upper portion comprising a reverse flange;
a lower plastic portion comprising anti-rotation legs that prevent rotation of the button, the anti-rotation legs that are retained by the apertures, the lower plastic portion being injection-molded onto the reverse flange wherein the reverse flange fixes the position of the plastic lower portion with respect to the upper metal portion; and
forming an actuator nub that actuates a switch on the flexible printed circuit when the button is depressed.

48. The method of claim 47 further comprising lathing the metal central portion of the button wherein the metal central portion comprises at least one annulus having a thickness of less than 0.4 millimeters.

49. The method of claim 47 further comprising forming a flange in the plastic annular portion, said flange used for fixing the location of the plastic annular portion along a longitudinal axis of the button.

50. The method of claim 47 further comprising incorporating the button in a portable media player.

51. The method of claim 47 further comprising incorporating the button in a handheld media player.

52. A method of manufacturing an electronic device comprising:
forming a base plate comprising a plurality of apertures;
forming a flexible printed circuit board that is adapted to receive user stimulus and transmit user commands to a microprocessor in response to the stimulus; and
forming a metal button comprising:
a concave face; and
an underside, the underside comprising a actuator nub that actuates a switch on the flexible printed circuit when the button is depressed and flexible printed circuit board relief that allows at least a portion of the flexible printed circuit board to traverse the boundary of the underside of the metal button.

53. The method of claim 50 further comprising lathing the metal central portion of the button wherein the metal central portion comprises at least one annulus having a thickness of less than 0.4 millimeters.

54. The method of claim 50 further comprising forming a flange in the plastic annular portion, said flange used for fixing the location of the plastic annular portion along a longitudinal axis of the button.

55. The method of claim 52 further comprising incorporating the button in a portable media player.

56. The method of claim 52 further comprising incorporating the button in a handheld media player.

57. A button comprising: a first portion and a second portion, the first portion comprising a plastic portion and the second portion comprising a metal portion, the metal portion of the button being matched to a metal material of a housing hosting the button.

58. The button of claim 57 wherein the plastic portion comprises a flange that is operative to interlock with a surface and the flange prevents movement of the button along a longitudinal axis of the button.

59. The button of claim 57, wherein the metal portion comprises a centrally-located nub on the underside of the metal portion and operative to actuate a dome switch.

60. The button of claim 57, wherein the metal portion comprises an annulus with a thickness along a longitudinal axis of between about 0.3 millimeters and about 0.5 millimeters.

61. The button of claim 57, wherein the metal portion comprises an annulus along a longitudinal axis of the button of less than about 0.5 millimeters.

62. The button of claim 57, wherein the metal portion is formed on a computer-numeric controlled lathe.

63. The button of claim 57 wherein the metal portion comprises anodized aluminum.

64. A button comprising: a metal upper portion comprising an annulus with a thickness along a longitudinal axis of between 0.3 millimeters and 0.4 millimeters, and a plastic lower portion, a portion of the plastic lower portion being injection-molded, wherein the position of the plastic lower portion is fixed with respect to the metal upper portion and the metal upper portion of the button is matched to a metal material of a housing hosting the button.

65. The button of claim 64, wherein the plastic lower portion comprises a flange that is operative to interlock with a surface and the flange prevents upward movement of the button along a longitudinal axis of the button.

66. The button of claim 64, wherein the metal upper portion comprises a centrally-located nub on the underside of the metal upper portion that is operative to actuate a dome switch.

67. The button of claim 64 wherein the metal upper portion comprises anodized aluminum.

68. An electronic device comprising: a base plate comprising multiple apertures, a flexible printed circuit board that is operative to receive user stimulus and transmit user commands to a microprocessor in response to the stimulus, and a button comprising a metal upper portion, the metal upper portion of the button being matched to a metal material of a housing hosting the button, a plastic lower portion, the plastic lower portion being injection-molded, and an actuator nub that actuates a switch on the flexible printed circuit when the button is depressed.

69. The device of claim 68, wherein the plastic lower portion comprises a flange that is operative to interlock with a surface and the flange prevents movement of the button along a longitudinal axis of the button.

70. The device of claim 68, wherein the metal upper portion comprises a centrally-located nub on the underside of the metal upper portion and operative to actuate a dome switch.

71. The device of claim 68, wherein the metal upper portion comprises an annulus with a thickness along a longitudinal axis of between about 0.3 millimeters and about 0.5 millimeters.

72. The device of claim 68, wherein the metal upper portion comprises an annulus along a longitudinal axis of the button of less than about 0.5 millimeters.

73. The device of claim 68, wherein the metal upper portion comprises anodized aluminum.
